(19) United States
(12) Patent Application Publication
(10) Pub. No.: US 2018/0278050 A1
(43) Pub. Date: Sep. 27, 2018

(54) Overvoltage Protection Device

(71) Applicant: STMICROELECTRONICS (TOURS) SAS, Tours (FR)

(72) Inventor: Philippe Rabier, Joue-Ies-Tours (FR)

(21) Appl. No.: 15/800,263

(22) Filed: Nov. 1, 2017

(30) Foreign Application Priority Data
Mar. 27, 2017 (FR) 1752516

(51) Int. Cl. H02H 9/04; H02H 7/18; H02J 7/00

(52) U.S. Cl. CPC H02H 9/04; H02J 7/0029; H02H 7/18

(57) ABSTRACT

In some embodiments, a device includes, in series: a bidirectional diode having a breakdown voltage that is higher than or equal to the supply voltage; and a unidirectional diode having a breakdown voltage that is higher than or equal to the supply voltage. One of the diodes is an avalanche diode and the other is a Shockley diode.

### CROSS-REFERENCE TO RELATED APPLICATIONS

This application claims priority to French Application No. 1752516, filed on Mar. 27, 2017, which application is hereby incorporated herein by reference.

### TECHNICAL FIELD

The present application relates generally to an electronic device and, in particular embodiments, to an overvoltage protection device.

### BACKGROUND

A vehicle is an environment that is subject to numerous disruptions. As such, the electronic circuits of a vehicle must most especially be protected against over-voltages. An overvoltage protection device is a component that is activated when the voltage across its terminals exceed a certain threshold, commonly referred to as the breakdown voltage. An avalanche diode or a Shockley diode may, for example, constitute an elementary overvoltage protection device.

The power supply of a vehicle generally consists of a battery delivering a nominal voltage VBat, for example equal to 12 V for a car battery. The overvoltage protection device is therefore designed to be triggered in the event of over-voltages having a value that is higher, in terms of absolute value, than the maximum nominal voltage VBat delivered by the battery.

When the battery of a vehicle no longer holds enough charge to start it, it is possible to connect the battery in parallel with another battery for the same type of vehicle, a battery for another type of vehicle or a battery charger able to deliver a voltage that is higher than the nominal voltage VBat delivered by the battery of the vehicle. Depending on the type of vehicle, the voltage VBat may take values that are for example equal to 6, 12, 24 or 48 V. Since a truck battery generally delivers a voltage VBatExt that is equal to twice that of a car, connecting a truck battery to a car battery would risk triggering the overvoltage protection device that is calibrated for a car battery voltage VBat.

However, for test and maintenance reasons, the polarity of the battery is intentionally reversed. In this case, protection capable of withstanding a voltage that is equal to the inverse of the voltage of the battery of the vehicle, −VBat, is required.

### SUMMARY

There is, therefore, a need in the art for a protection device that protects electronic circuits of a vehicle against over-voltages but allows connection to a power source delivering a voltage VBatExt that is higher than the voltage VBat and allows the battery of the vehicle to be connected in inverse configuration.

Thus, some embodiments include an overvoltage protection device suitable for protecting components linked to a power supply line.

One embodiment envisages a device for protecting against positive over-voltages having a value that is higher than VBatExt and against negative over-voltages having a value that is lower than −VBat.

A device for protecting a circuit intended to receive a supply voltage is envisaged, this device including, in series: a bidirectional diode having a breakdown voltage that is higher than or equal to the supply voltage; and a unidirectional diode having a breakdown voltage that is higher than or equal to the supply voltage, one of the diodes being an avalanche diode and the other being a Shockley diode.

According to one embodiment, the avalanche diode is unidirectional and the Shockley diode is bidirectional.

According to one embodiment, the avalanche diode is bidirectional and the Shockley diode is unidirectional and is connected in antiparallel with a rectifier diode.

According to one embodiment, the supply voltage is between 6 and 48 V.

According to one embodiment, the circuit to be protected includes circuits of a vehicle and the supply voltage is the nominal voltage of a vehicle battery.

According to one embodiment, the circuit to be protected includes electronic, logic and/or analogue circuits.

### BRIEF DESCRIPTION OF THE DRAWINGS

These features and advantages, and others, will be described in detail in the following non-limiting description of particular embodiments, which is given with reference to the appended figures, in which:

FIG. 1A is a circuit diagram of one embodiment of an overvoltage protection device;

FIG. 1B illustrates the voltage-current characteristic of the device of FIG. 1A;

FIG. 2A is a circuit diagram of another embodiment of an overvoltage protection device; and

FIG. 2B illustrates the voltage-current characteristic of the device of FIG. 2A.

### DETAILED DESCRIPTION OF ILLUSTRATIVE EMBODIMENTS

The same elements have been referenced by the same references in the various figures. For the sake of clarity, only those elements which are useful to the comprehension of the described embodiments have been shown and are described in detail.

Unless otherwise specified, the expression “of the order of” means to within 10% and preferably to within 5%.

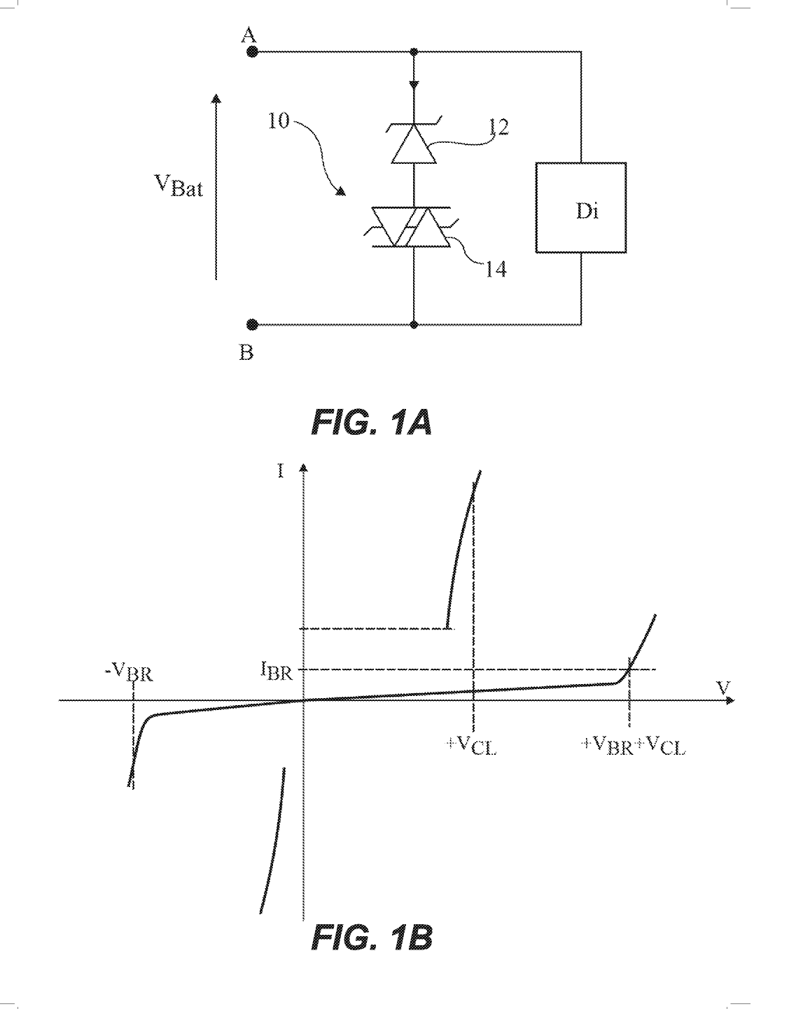

FIG. 1A illustrates one embodiment of a protection device suitable for protecting electronic circuits of a car against positive over-voltages having a value that is higher than the nominal voltage of a truck battery and against negative over-voltages having a value that is higher, in terms of absolute value, than the nominal voltage of a car battery.

FIG. 1A is a circuit diagram illustrating a protection device 10 connected between a node A and a node B of a device Di to be protected. The device Di includes, for example, electronic, logic and/or analog circuits. The device 10 includes, in series between the nodes A and B, a unidirectional avalanche diode 12 and a bidirectional Shockley diode 14. The anode of the avalanche diode 12 is linked to the node A and its cathode is linked to one of the terminals of the Shockley diode 14. The device Di is connected by its terminals A and B to a battery delivering a nominal voltage VBat. As a variant, the anode of the avalanche diode 12 could be linked to one of the terminals of the bidirectional Shockley diode 14 and its cathode could be linked to the node B.

FIG. 1B illustrates the current-voltage characteristic of the device 10. The avalanche diode has an avalanche voltage VCL that is higher than the nominal voltage VBat of a car battery. The avalanche voltage VCL is, for example, of the order of 13 V for a car battery having a nominal voltage VBat of 12 V. The Shockley diode 14 has a positive breakdown voltage VBR that is higher than the nominal voltage VBat delivered by the car battery and a negative breakdown voltage that is equal to the inverse of the positive breakdown voltage −VBR. The positive VBR and negative −VBR breakdown voltages are for example 14 V and −14 V for a car battery delivering a nominal voltage VBat of 12 V. The protection device 10 therefore has a positive breakdown voltage that is equal to the sum of the avalanche voltage VCL of the avalanche diode 12 and of the positive breakdown voltage VBR of the Shockley diode 14. The device 10 has a negative breakdown voltage that is equal to the negative breakdown voltage −VBR of the Shockley diode 14.

Thus, the device 10 is triggered for positive over-voltages having a value that is higher than the nominal voltage VBatExt of a truck battery and for negative over-voltages having a value that is higher, in terms of absolute value, then the nominal voltage of a car VBat.

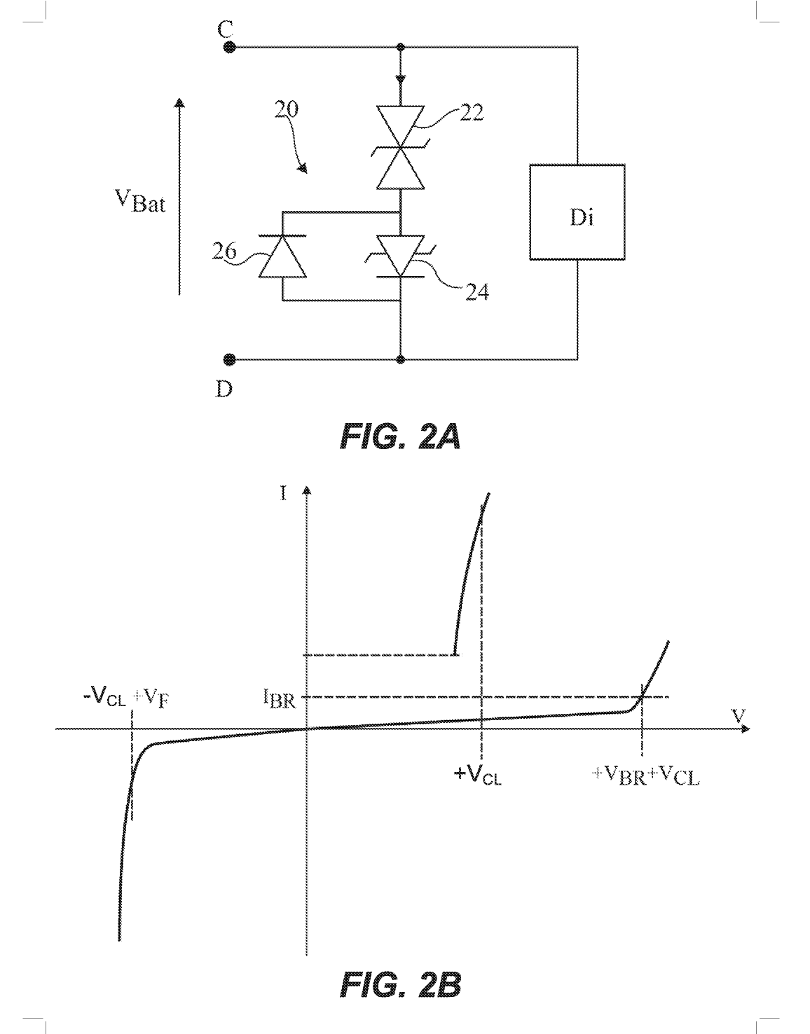

FIG. 2A illustrates another embodiment of a protection device suitable for protecting electronic circuits of a car against positive over-voltages having a value that is higher than that of a truck battery VBatExt and against negative over-voltages having a value that is higher, in terms of absolute value, than the voltage of a car battery VBat.

FIG. 2A is a circuit diagram of a protection device 20 connected between a node C and a node D of the device Di to be protected. The protection device 20 includes, in series between the nodes C and D, a bidirectional avalanche diode 22 and a unidirectional Shockley diode 24. The anode of the Shockley diode 24 is connected to the node D and its cathode is connected to the avalanche diode 22. The device 20 additionally includes a diode 26 connected in antiparallel with the Shockley diode 24. The device Di is connected by its terminals C and D to a battery delivering a voltage VBat. As a variant, the anode of the Shockley diode 24 could be linked to one of the terminals of the avalanche diode 22 and its cathode could be linked to the node C.

FIG. 2B illustrates the voltage-current characteristic of the device 20. The avalanche diode 22 has a positive avalanche voltage VCL that is higher than the nominal voltage VBat of a battery of a vehicle and a negative avalanche voltage that is equal to the inverse of the positive avalanche voltage −VCL. The positive VCL and negative −VCL avalanche voltages are for example of the order of 13 V and −13 V for a nominal voltage VBat of 12 V. The Shockley diode 24 has a breakdown voltage VBR that is higher than the nominal voltage VBat of a battery of a vehicle. The breakdown voltage VBR is for example of the order of 14 V for a battery of a vehicle having a nominal voltage of 12 V. The diode 26 is a rectifier diode having a forward voltage drop, VF, of the order of 0.6 V. The device 20 has a positive breakdown voltage that is equal to the sum of the positive avalanche voltage VCL of the avalanche diode 22 and of the breakdown voltage VBR of the Shockley diode 24. In addition, since the avalanche diode 22 is bidirectional, the device 20 has a negative breakdown voltage that is equal to the sum of the negative avalanche voltage −VCL of the diode 22 and of the forward voltage drop VF of the diode 26.

Thus, the device 20 is triggered for positive over-voltages having a value that is higher than the nominal voltage of a truck battery and for negative over-voltages having a value that is higher, in terms of absolute value, than the nominal voltage of a car.

As shown in FIGS. 1B and 2B, for positive over-voltages, the electrical behaviors of the devices 10 and 20 are identical. However, for negative over-voltages, the behavior of the device 10, described with reference to FIG. 1B, is that of a Shockley diode and the behavior of the device 20, described with reference to FIG. 2B, is that of an avalanche diode. In the case of a car, operating as an avalanche diode is not a drawback since, in general, the negative over-voltages that occur in a car are of low energy.

In addition, if the connections of a battery of a vehicle are inverted, it will deliver a voltage −VBat to the protection device 10, 20 and to the device Di to be protected. Since the protection device 10, 20 is triggered only for negative over-voltages having values that are lower than −VBat, the battery will not be shorted and will therefore not be damaged.

Particular embodiments have been described. Diverse variants and modifications will be apparent to those skilled in the art. In particular, this overvoltage protection device may be used in any environment and not only that of a vehicle.

Various embodiments with various variants have been described above. It should be noted that a person skilled in the art could combine various elements of these various embodiments and variants without exercising inventive skill.

What is claimed is:

1. A protection device configured to be coupled to a circuit and configured to receive a supply voltage, the protection device comprising:
a bidirectional diode having a breakdown voltage that is higher than or equal to the supply voltage; and
a unidirectional diode coupled in series with the bidirectional diode, the unidirectional diode having a breakdown voltage that is higher than or equal to the supply voltage, wherein one of the bidirectional or unidirectional diodes is an avalanche diode and the other of the bidirectional or unidirectional diodes is a Shockley diode.

2. The protection device of claim 1, wherein the unidirectional diode is an avalanche diode and the bidirectional diode is a Shockley diode.

3. The protection device of claim 1, wherein the bidirectional diode is an avalanche diode and the unidirectional diode is a Shockley diode and is connected in antiparallel with a rectifier diode.

4. The protection device of claim 1, wherein the supply voltage is between 6 V and 48 V.

5. The protection device of claim 1, wherein the circuit comprises circuits of a vehicle and wherein the supply voltage is a nominal voltage of a battery of the vehicle.

6. The protection device of claim 1, wherein the circuit comprises digital or analog circuitry.

7. A system comprising:
a pair of battery terminals configured to receive a supply voltage;
a circuit coupled to the pair of battery terminals; and
a protection device coupled across the pair of battery terminals, wherein the protection device comprises:
a bidirectional diode having a breakdown voltage that is higher than or equal to the supply voltage; and
a unidirectional diode coupled in series with the bidirectional diode, the unidirectional diode having a breakdown voltage that is higher than or equal to the supply voltage, wherein one of the bidirectional or unidirectional diodes is an avalanche diode and the other of the bidirectional or unidirectional diodes is a Shockley diode.

8. The system of claim 7, further comprising a car battery coupled to the pair of battery terminals.

9. The system of claim 7, wherein the unidirectional diode is the avalanche diode and the bidirectional diode is the Shockley diode.

10. The system of claim 9, wherein the Shockley diode has a positive breakdown voltage of 14 V and a negative breakdown voltage of 14 V, and wherein the avalanche diode has an avalanche voltage of 13 V.

11. The system of claim 7, wherein an anode of the unidirectional diode is directly connected to the bidirectional diode.

12. The system of claim 7, wherein the unidirectional diode is the Shockley diode and the bidirectional diode is the avalanche diode, and the system further comprises a rectifier diode having an anode coupled to a cathode of the unidirectional diode and cathode coupled to an anode of the unidirectional diode.

13. The system of claim 12, wherein the Shockley diode has a breakdown voltage of 14 V, the avalanche diode has a positive avalanche voltage of 13 V and a negative avalanche voltage of −13 V, and the rectifier diode has a forward voltage drop of 0.6 V.

14. A method for protecting a circuit, the method comprising:
receiving a supply voltage across a pair of battery terminals coupled to the circuit;
when the supply voltage is positive and higher than a first threshold, turning on a protection device coupled across the pair of battery terminals, wherein the protection device comprises
a bidirectional diode having a positive breakdown voltage that is higher than or equal to the supply voltage and a negative breakdown voltage that is equal in magnitude than the positive breakdown voltage, and
a unidirectional diode coupled in series with the bidirectional diode, the unidirectional diode having a breakdown voltage that is higher than or equal to the supply voltage, wherein one of the bidirectional or unidirectional diode is an avalanche diode and the other of the bidirectional or unidirectional diode is a Shockley diode; and
when the supply voltage is negative and higher in magnitude than a second threshold, turning on the protection device, wherein turning on the protection device comprises conducting current through the protection device.

15. The method of claim 14, wherein the first threshold corresponds to the positive breakdown voltage of the bidirectional diode plus the breakdown voltage of the unidirectional diode.

16. The method of claim 15, wherein
the unidirectional diode is the avalanche diode;
the bidirectional diode is the Shockley diode; and
the second threshold corresponds to the negative breakdown voltage of the bidirectional diode.

17. The method of claim 16, wherein the first threshold is 27 V and the second threshold is −14 V.

18. The method of claim 15, wherein
the protection device further comprises a rectifier diode;
the unidirectional diode is the Shockley diode;
the bidirectional diode is the avalanche diode; and
the second threshold corresponds to the negative breakdown voltage of the bidirectional diode plus a forward voltage drop of the rectifier diode.

19. The method of claim 18, wherein the first threshold is 27 V and the second threshold is −13.6 V.

20. The method of claim 14, wherein an anode of the unidirectional diode is directly connected to the bidirectional diode.
